(19) United States
(12) Patent Application Publication
(10) Pub. No.: US 2010/0177692 A1
(43) Pub. Date: Jul. 15, 2010

(54) METHOD AND DEVICE FOR MANAGING COMMUNICATION SESSION

(75) Inventor: Jose Luis Gil, Barcelona (ES)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/602,894

(22) PCT Filed: Aug. 19, 2008
(86) PCT No.: PCT/US08/73542

§ 371 Date: Dec. 3, 2009

(30) Foreign Application Priority Data
Aug. 31, 2007 (GB) 0716830.5

(51) Int. Cl. H04W 40/00

(52) U.S. Cl. 370/328

(57) ABSTRACT

A method and device for managing a communication session via a plurality of wireless carriers in a wireless communication network (100) is disclosed. The network includes a plurality of regions. The method at a first network-controller (108) in a first region (104) of the plurality of regions includes maintaining the communication session with a communication device (112) in a second region (106) of the network via a first set of wireless carriers of the plurality of wireless carriers when the communication device moves from the first region (104) to the second region. Each wireless carrier of the plurality of wireless carriers corresponds to one or more distinct data-packets. The method also includes the one or more distinct data-packets being provided to the communication device via the first set of wireless carriers.

### FIELD OF THE INVENTION

This invention generally relates to communication networks, and more specifically, to a method and device for managing a communication session in a wireless communication network.

### BACKGROUND OF THE INVENTION

Communication networks have become increasingly popular with the increased need for information and communication exchange. Examples of communication network can include, for example, a Code Division Multiple Access (CDMA) network, a General Packet Data Service (GPRS) network, a Universal Mobile Telecommunications System (UMTS), and a Global System for Mobile Communication (GSM) network. A communication network can include a plurality of communication devices and one or more network-controllers. Some examples of a communication device include a personal computer, a mobile phone, a laptop, and a Personal Digital Assistant (PDA). A network-controller can provide services such as a Wireless Application Protocol (WAP) access, a Short-Messaging Service (SMS), a multimedia-messaging service (MMS), an electronic-mail (e-mail) and Internet access to a communication device. Data transmitted by the network-controller to a communication device can be transmitted as data-packets. An example of a network-controller can include a base-station controller.

A network-controller influences and/or controls an area in a communication network. This area is often referred to as a region. A communication network can include one or more regions. During a communication session, a communication device can move from one region to another region of the communication network. For example, a user who is engaged in a communication session can move from a first region to a second region while driving a vehicle. In such a scenario, a network-controller corresponding to the first region may be unaware of the movement of the communication device from the first region to the second region. In the second region, the network-controller of the first region can not transfer one or more distinct data-packets corresponding to the communication device. For example, in the case of a GPRS network, the network-controller may be unaware of the movement of the communication device from one region to another. As a result, the data transfer rate can be a reduced due to data packets being dropped during the frequent movement of the communication device from one region to another. This reduced data transfer rate can cause inconvenience to end-users due to number of timeouts in the communication session, since the network-controller can abort the data-transfer with the communication device.

### SUMMARY OF THE INVENTION

According to an aspect of the invention, there is provided a method for managing a communication session in accordance with claim 1.

According to another aspect of the invention, there is provided a method for managing a communication session in accordance with claim 8.

According to another aspect of the invention, there is provided a communication device in accordance with claim 15.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with examples of the present invention.

FIG. 1 illustrates an exemplary wireless communication network, in accordance with one embodiment of the present invention;

FIG. 2 illustrates a communication device, in accordance with one embodiment of the present invention;

FIG. 3 is a flow diagram illustrating a method for managing a communication session, in accordance with one embodiment of the present invention; and

FIG. 4 is a flow diagram illustrating a method for managing a communication session, in accordance with another embodiment of the present invention.

### DETAILED DESCRIPTION

For one embodiment, a method for managing a communication session via a plurality of wireless carriers in a wireless communication network is provided. The wireless communication network can include a plurality of regions. The method at a first network-controller in a first region of the plurality of regions includes maintaining the communication session with a communication device in a second region of the wireless communication network when the communication device moves from the first region to the second region. The communication session is maintained via a first set of wireless carriers of the plurality of wireless carriers. Each wireless carrier of the plurality of wireless carriers corresponds to one or more distinct data-packets. Moreover, the method includes providing the one or more distinct data-packets to the communication device via the first set of wireless carriers.

For another embodiment, a method for managing a communication session via a plurality of wireless carriers in a wireless communication network is provided. The wireless communication network can include a plurality of regions. The method at a communication device includes maintaining the communication session with a first network-controller via a first set of wireless carriers of the plurality of wireless carriers when the communication device moves from a first region to a second region of the wireless communication network. Each wireless carrier of the plurality of wireless carriers corresponds to one or more distinct data-packets. The first network-controller corresponds to the first region of the wireless communication network. Moreover, the method includes receiving the one or more distinct data-packets from the first network-controller via the first set of wireless carriers.

For yet another embodiment, a communication device is provided. The communication device includes a processor module and a receiver module. The processor module can be adapted to manage a communication session with a first network-controller in a wireless communication network. The communication session is managed via a first set of wireless carriers of the plurality of wireless carriers when the communication device moves from a first region to a second region of the wireless communication network. Each wireless carrier of the plurality of wireless carriers corresponds to one or more distinct data-packets. The first network-controller corresponds to the first region of the wireless communication network. The receiver module can be adapted to receive the one or more distinct data-packets from the first network-controller via the first set of wireless carriers.

Before describing in detail the particular method and device for managing a communication session in a wireless communication network, in accordance with various embodiment of the present invention, it should be observed that the present embodiments of the invention resides primarily in combinations of method steps and/or apparatus components related to the method and device for managing the communication session in the wireless communication network. Accordingly, the method steps and apparatus components have been represented where appropriate by conventional symbols in the drawings, showing only those specific details that are pertinent for an understanding of the embodiments of the present invention, so as not to obscure the disclosure with details that will be readily apparent to those with ordinary skill in the art, having the benefit of the description herein.

In this document, relational terms such as first and second, and the like may be used solely to distinguish one entity or action from another entity or action without necessarily requiring or implying any actual such relationship or order between such entities or actions. The terms ‘comprises,’ ‘comprising,’ or any other variation thereof, are intended to cover a non-exclusive inclusion, such that a process, method, article, or apparatus that comprises a list of elements does not include only those elements but may include other elements not expressly listed or inherent to such a process, method, article, or apparatus. An element proceeded by ‘comprises . . . a’ does not, without more constraints, preclude the existence of additional identical elements in the process, method, article, or apparatus that comprises the element.

The term ‘another,’ as used in this document, is defined as at least a second or more. The term ‘includes,’ as used herein, is defined as comprising. The term ‘can,’ as used herein, should be interpreted in an open-ended manner, such as the word ‘may’ is interpreted rather than in a restrictive manner, such as the word ‘must’ is interpreted.

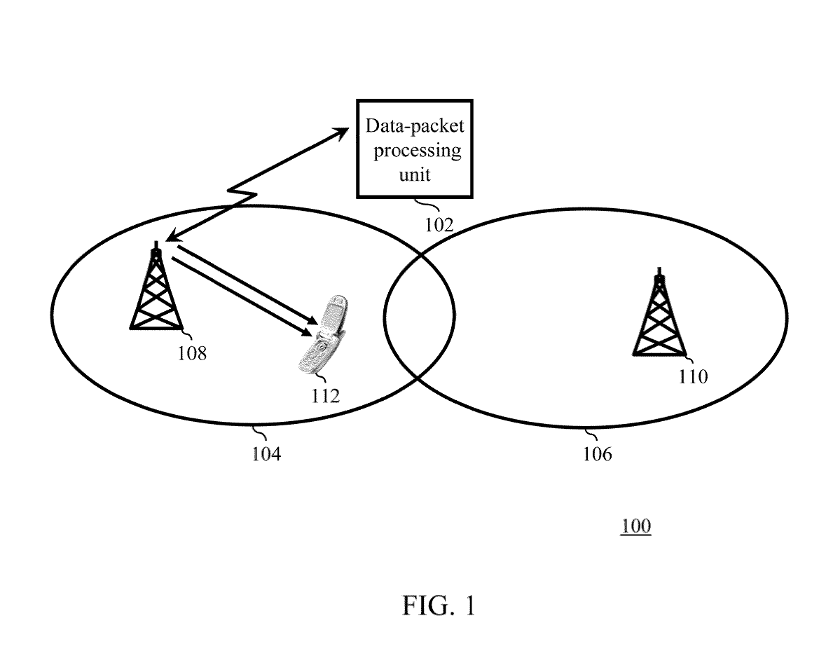

FIG. 1 illustrates an exemplary wireless communication network 100, in accordance with one embodiment of the present invention. Examples of the wireless communication network 100 include, but are not limited to, an Institute of Electrical and Electronic Engineers (IEEE) 802.16-based broadband wireless access network, an Advanced Mobile Phone Systems (AMPS) network, a Global System for Mobile (GSM) communications network, a Digital Cellular Systems (DCS) network, a Universal Mobile Telecommunication Systems (UMTS) network, a Code Division Multiple Access (CDMA) network, a General Packet Radio Service (GPRS) network, an Enhance Data Rates for GSM evolution (EDGE), a Digital Enhanced Cordless Telecommunications (DECT), and an integrated Digital Enhanced Network (iDEN). The wireless communication network 100 can include a data-packet processing unit and one or more network-controllers. Each network-controller of the one or more network-controllers can control a region of the wireless communication network 100. The data-packet processing unit can provide one or more distinct data-packets, corresponding to a communication session to a network-controller of a region, in which a communication device is operating. The network-controller can provide services such as a Wireless Application Protocol (WAP) access, a Short-Messaging Service (SMS), a Multimedia-Messaging Service (MMS), an electronic-mail (e-mail) and Internet access to a communication device. Examples of the network-controller can include a web-based network-controller and a mobile-data based network-controller. The web-based network-controller can receive a request from a communication device and provide information related to the request. For example, a web-based network-controller can receive a request from a mobile phone and provide information related to the request through the Internet. A mobile-data based network-controller, for example, a Base-Station Controller (BSC), Base Transceiver Station (BTS) used in GSM/GPRS-, node B and RNC (used in UMTS), or access points (used in 802.11/16/20 technologies) can provide voice and data services to a communication device in the wireless communication network. Examples of a communication device can include a personal computer, an Internet Protocol (IP)-enabled phone, a mobile phone, a laptop-computer, and a Personal-Digital Assistant (PDA). Data transmitted by a network-controller to a communication device can be formatted as data-packets.

For one embodiment, a network-controller can establish a communication session with a communication device via a plurality of wireless carriers. The network-controller can provide one or more distinct data-packets corresponding to the communication session to the communication device via each of the plurality of wireless carriers. Examples of a communication session can include, but are not limited to, a voice call, a Voice Over Internet Protocol (VoIP)-call, a push-to-talk session, a data session, an Internet session, a file download, a web-browsing session, a net-meeting session, a dispatch group session, a voice conference, and a video conference.

For the purpose of this description, the wireless communication network 100 has been shown to include a data-packet processing unit 102 and a region 104 and a region 106. The region 104 is under the control of the network-controller 108 and the region 106 is under the control of the network-controller 110. Further, the wireless communication network 100 is shown to include a communication device 112, which maintains a communication session with the network-controller 108 in the region 104 via a plurality of wireless carriers. Each wireless carrier of the plurality of wireless carriers can correspond to one or more distinct data-packets.

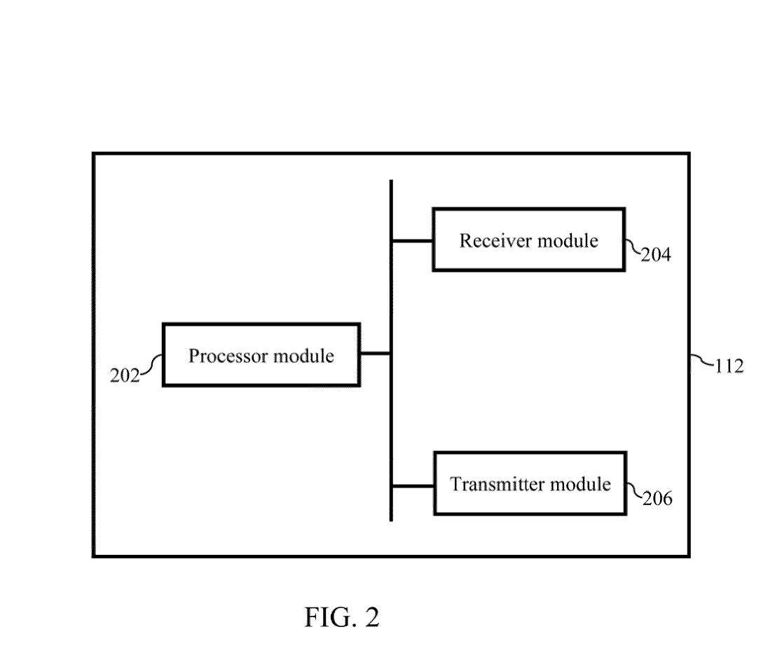

FIG. 2 illustrates a block diagram of the communication device 112, in accordance with one embodiment of the present invention. Examples of the communication device 112 can include, but are not limited to, a mobile-phone, a pager, a laptop computer, a personal-computer, a multi-modal phone, and a Personal-Digital Assistant (PDA). The communication device 112 can include a processor module 202 and a receiver module 204. The communication device 112 can receive a communication-session from a network-controller. For example, from either the network-controller 108 or 110 in the wireless communication network 100 via a plurality of wireless carriers. Each wireless carrier of the plurality of wireless carriers can correspond to one or more distinct data-packets. The processor module 202 can manage a communication session with a first network-controller in a wireless communication network when the communication device moves from a first region to a second region of the wireless communication network. The first network-controller corresponds to the first region of the communication network. The communication session can be managed via a first set of wireless carriers of the plurality of wireless carriers. The first network-controller provides the one or more distinct data-packets to the communication device 112. The one or more distinct data-packets are received by the receiver module 204 via the first set of wireless carriers.

For one embodiment, the communication device 112 includes a transmitter module 206. The transmitter module 206 can send a request to the first network-controller to manage the communication session when the communication device 112 moves from the first region to the second region of the wireless communication network 100. Once the communication is established between the communication device 112 and the first network-controller, the transmitter module 206 can transmit data to the first network-controller and the second network-controller simultaneously. In this embodiment, the transmitter module 206 transmits data to the first network-controller via the first set of wireless carries and to the second network-controller via the second set of wireless carriers. For one embodiment, the transceiver module 206 can transmit data to a plurality of network-controllers simultaneously. For another embodiment, the transmitter module 206 can transmit data to a plurality of wireless communication network technologies simultaneously. After receiving the one or more distinct data-packets from the first network-controller, the transmitter module 206 can send a message acknowledging the receipt of the one or more distinct data-packets to the first network-controller. After, the acknowledgement has been received from the communication device 112; the first set of wireless carriers is released from the communication device 112.

The receiver module 204 can also receive the communication session from the second network-controller via a second set of wireless carriers of the plurality of wireless carriers in the second region simultaneously while receiving data from the first network-controller via the first set of wireless carriers. The second network-controller corresponds to the second region.

The communication device 112, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps constituting the method of the present invention.

A computer system may comprise a computer, an input device, a display unit, and components enabling connectivity to networks such as the Internet. The computer comprises one or more microprocessors connected to a communication bus. The computer also includes memory, which may include Random Access Memory (RAM) and/or Read Only Memory (ROM). Furthermore, the computer system may comprise one or more additional storage devices such as a hard disk drive or a removable storage drive (such as a floppy disk drive, an optical disk drive, or the like) or other similar means for loading computer programs/instructions into the computer system. The computer system executes a set of instructions that are stored in one or more storage elements, in order to process input data. The storage elements may also hold data or other information as desired. The storage element may be in the form of an information source or a physical memory element present in the processing machine.

The various functions performed by the communication device 112, as described in the present embodiment or any of its components, can be implemented using computer program instructions and/or hardware.

Although the present embodiment is explained with help of a communication device including one transmitter module and one receiver module, however it will be apparent to a person ordinarily skilled in the art that the communication device of this invention can e.g. include a plurality of transmitter modules to transmit data to a plurality of network-controllers utilizing one or more network technologies; and a plurality of receiver modules to receive data from a plurality of network-controllers utilizing one or more network technologies.

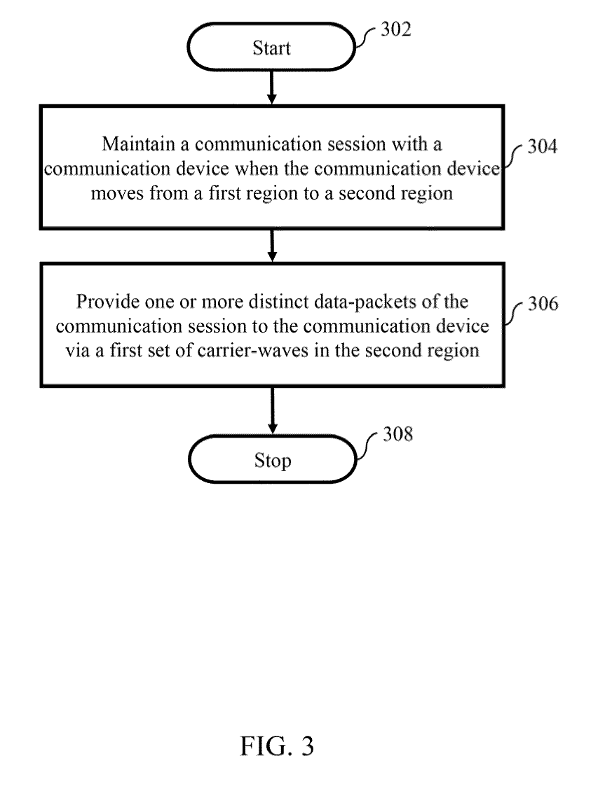

FIG. 3 is a flow diagram illustrating a method for managing a communication session, in accordance with one embodiment of the present invention. The communication session between the communication device and the first network-controller can be conveyed, via a plurality of wireless carriers in the wireless communication network. Each wireless carrier of the plurality of wireless carriers may correspond to one or more distinct data-packets. The communication device can move from a first region to a second region of the wireless communication network. For example, a user talking on a mobile phone while driving a car can move from one region to another region of the wireless communication network.

The method at the first network-controller in the first region is initiated at step 302. At step 304, the first network-controller maintains the communication session with the communication device in the second region of the wireless communication network. The communication session is maintained via a first set of wireless carriers of the plurality of wireless carriers in the second region. For one embodiment, the first network-controller can receive a request from the communication device for managing the communication session when the communication device moves from the first region to the second region.

At step 306, the first network-controller provides the one or more distinct data-packets to the communication device via the first set of wireless carriers. For one embodiment, the communication device sends an acknowledgement to first network-controller on receipt of the one or more distinct data-packets. In one embodiment, the first network-controller can release the first set of wireless carriers with the communication device on receipt of the acknowledgement. In another embodiment, the communication device sends a request to the first network-controller to release the first set of wireless carriers associated with the communication device. In an embodiment, the communication device informs the second network-controller in the second region to assign a third set of wireless carrier to the communication device. The third set of wireless carriers comprises the wireless carriers based on the first set of wireless carriers. The second network-controller corresponds to the second region.

The method given above is illustrated with reference to the following example for clarity. The wireless communication network 100 can include one or more regions, for example, the regions 104 and 106. As illustrated in FIG. 1, a communication session is maintained between the communication device 112 and the network-controller 108 via a plurality of wireless carriers. For example, ‘N’ number of wireless carriers can be used to maintain the communication session between the communication device 112 and the network-controller 108. The network-controller 108 can provide one or more distinct data-packets, corresponding to the communication session to the communication device 112 via each of the plurality of wireless carriers. The communication device 112 can move from the region 104 to the region 106 during the communication session. The data-packet processing unit 102 may notify the network-controller 110 about the presence of the communication device 112 in the region 106.

In the region 106, the network-controller 108 can maintain the communication session with the communication device 112 via a first set of wireless carriers. For example, the first set of wireless carriers used to maintain the communication session between the communication device 112 and the network-controller 108 may include ‘X’ number of wireless carriers. The remaining wireless carriers ‘N-X’ can be used to establish the communication session between the network-controller 110 and the communication device 112. The communication device 112 can simultaneously receive the one or more distinct data-packets from the network-controller 108 and the network-controller 110. When the communication device 112 acknowledges the receipt of the one or more distinct data-packets that were buffered at the network-controller 108, the network-controller 108 can release the ‘X’ wireless carriers with the communication device 112. Further, the network-controller 110 can support the communication session with the communication device 112 via a third set of wireless carriers. The third set of wireless carriers may include an ‘X’ number (or perhaps less) of wireless carriers as in the first set of wireless carriers.

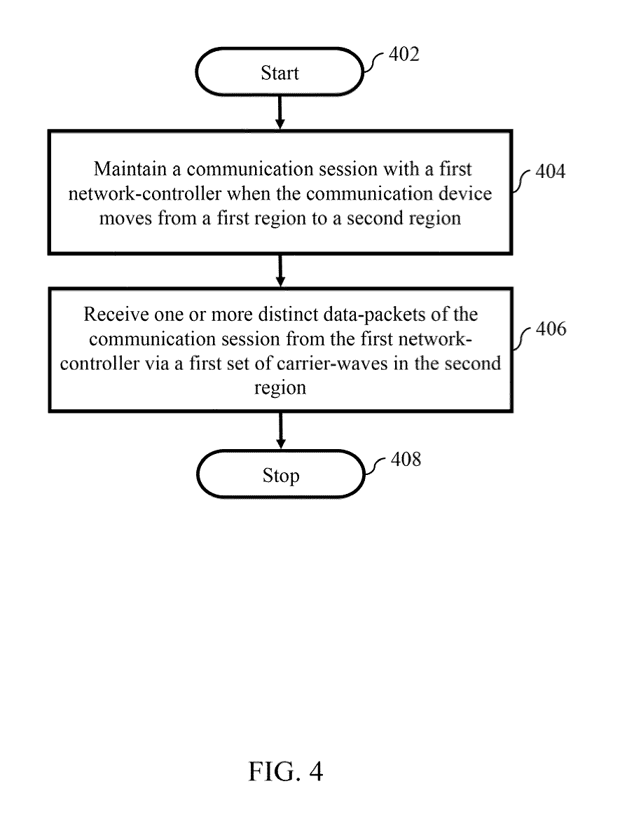

FIG. 4 is a flow diagram illustrating a method for managing a communication session, in accordance with another embodiment of the present invention. The communication session between the communication device and the first network-controller is established via a plurality of wireless carriers. For example, the communication device 112 can establish a communication session with the first network-controller 108 via a plurality of wireless carriers. For one embodiment of the present invention, the receiver module 204 of the communication device 112 is adapted to receive the plurality of wireless carriers from the network-controller 108. The method for managing the communication session is initiated at step 402. At step 404, the communication device maintains the communication session with the first network-controller via a first set of wireless carriers of the plurality of wireless carriers. For one embodiment, the processor module 202 can maintain the communication session with the first network-controller. Each wireless carrier of the plurality of wireless carriers corresponds to one or more distinct data-packets. The first network-controller corresponds to the first region of the communication network. The communication device can receive the one or more distinct data-packets from the first network-controller via the first set of wireless carriers at step 406. For one embodiment, the receiver module 204 can receive the one or more distinct data-packets.

Further, the communication device can send a request to the first network-controller to manage the communication session when the communication device moves from the first region to the second region of the wireless communication network. For one embodiment, the transmitter module 206 can send a request to the first network-controller to manage the communication session. On receiving the one or more distinct data-packets, the communication device can acknowledge their receipt to the first network-controller. For one embodiment, the transmitter module 206 can send an acknowledgment to the first network-controller regarding the receipt. Further, on receipt, the communication device can request the first network-controller to release the first set of wireless carriers.

In the second region of the communication network, the communication device can receive data corresponding to the communication session via a second set of wireless carriers of the plurality of wireless carriers from a second network-controller. For one embodiment, the receiver module 204 can receive the communication session from the second network-controller 110 via the second set of wireless carriers. Thereafter, the method is terminated at step 408.

Various embodiments, as described above, provide a method and device for managing a communication session in a communication network. The embodiments provide a method and device for seamlessly handling a communication session of a communication device. The embodiments also provide a method for preventing degradation and/or loss of data-packets due to the movement of the communication device from one region to another of the communication network. Further, the embodiments are not specific to a particular technology and can be extended to any communication technology and communication standard.

In the foregoing specification, aspects of the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all of the claims. The invention is defined solely by the appended claims, including any amendments made during the pendency of this application and all equivalents of those claims as issued.

1. A method for managing a communication session via a plurality of wireless carriers in a wireless communication network, the wireless communication network comprising a plurality of regions, the method at a first network-controller in a first region of the plurality of regions comprising:
maintaining the communication session with a communication device in a second region of the wireless communication network via a first set of wireless carriers of the plurality of wireless carriers when the communication device moves from the first region to the second region, wherein each wireless carrier of the first set of wireless carriers corresponds to one or more distinct data-packets; and
providing the one or more distinct data-packets to the communication device via the first set of wireless carriers.

2. The method as recited in claim 1 further comprising receiving a request from the communication device for managing the communication session when the communication device moves from the first region to the second region.

3. The method as recited as claim 1 further comprising receiving an acknowledgement from the communication device when the one or more distinct data-packets are received by the communication device.

4. The method as recited in claim 1 further comprising releasing the first set of wireless carriers with the communication device when the one or more distinct data-packets are received by the communication device.

5. The method as recited in claim 4 further comprising receiving a request from the communication device to release the first set of wireless carriers when the one or more distinct data-packets are received by the communication device.

6. The method as recited in claim 1, wherein the first region is served by a first wireless communication network technology and the second region is served by a second wireless communication network technology.

7. The method as recited in claim 6, wherein each of the first and the second wireless communication network technologies comprises one of a Global System for Mobile (GSM) communications, a General Packet Radio Service (GPRS), a Code Division Multiple Access (CDMA), an Enhance Data Rates for GSM Evolution (EDGE), a Digital Enhanced Cordless Telecommunications (DECT), an integrated Digital Enhanced Network (iDEN), an Universal Mobile Telecommunications System, a High-Speed Downlink Packet Access (HSDPA), a Wireless-Fidelity network (802.11), and a Worldwide Interoperability for Microwave Access (802.16).

8. A method for managing a communication session via a plurality of wireless carriers in a wireless communication network, the wireless communication network comprising a plurality of regions, the method at a communication device comprising:
maintaining the communication session with a first network-controller via a first set of wireless carriers of the plurality of wireless carriers when the communication device moves from a first region to a second region of the wireless communication network, wherein each wireless carrier of the first set of wireless carriers corresponds to one or more distinct data-packets, and wherein the first network-controller corresponds to the first region of the wireless communication network; and
receiving the one or more distinct data-packets from the first network-controller via the first set of wireless carriers.

9. The method as recited in claim 8 further comprising sending a request to the first network-controller for managing the communication session when the communication device moves from the first region to the second region.

10. The method as recited in claim 8 further comprising receiving the communication session via a second set of wireless carriers of the plurality of wireless carriers from a second network-controller, wherein the second network-controller corresponds to the second region.

11. The method as recited as claim 8 further comprising sending an acknowledgement to the first network-controller when the one or more distinct data-packets are received from the first network-controller.

12. The method as recited in claim 11 further comprising informing a second network-controller in the second region to assign a third set of wireless carriers, wherein the third set of wireless carriers comprises wireless carriers that are based on the first set of wireless carriers, and wherein the second network-controller corresponds to the second region.

13. The method as recited in claim 8 further comprising sending a request to the first network-controller to release the first set of wireless carriers when the one or more distinct data-packets are received from the first network-controller.

14. The method as recited in claim 13 further comprising establishing a connection with a second network-controller via a third set of wireless carriers, wherein the third set of wireless carriers comprises the wireless carriers based on the first set of wireless carriers, and wherein the second network-controller corresponds to the second region.

15. A communication device comprising:
a processor module, the processor module arranged to manage a communication session with a first network-controller in a wireless communication network via a first set of wireless carriers of a plurality of wireless carriers when the communication device moves from a first region to a second region of the wireless communication network, wherein each wireless carrier of the plurality of wireless carriers corresponds to one or more distinct data-packets, and wherein the first network-controller corresponds to the first region; and
a receiver module, communicatively coupled to the processor module, the receiver module arranged to receive the one or more distinct data-packets from the first network-controller via the first set of wireless carriers.

16. The communication device as recited in claim 15 further comprising a transmitter module, the transmitter module is arranged to send a request to the first network-controller for managing the communication session when the communication device moves from the first region to the second region.

17. The communication device as recited in claim 16, wherein the transmitter module is further arranged to send an acknowledgement to the first network-controller when the one or more distinct data-packets are received from the first network-controller.

18. The communication device as recited in claim 15, wherein the receiver module is further arranged to receive the communication session from a second network-controller via a second set of wireless carriers of the plurality of wireless carriers, wherein the second network-controller corresponds to the second region.

19. The communication device as recited in claim 15 further comprising a transmitter arranged to transmit simultaneously to a plurality of network-controllers.

20. The communication device as recited in claim 15 further comprising a plurality of transmitters arranged to transmit simultaneously to a plurality of network-controllers.
